(19) United States
(12) Patent Application Publication
(10) Pub. No.: US 2007/0176788 A1
(43) Pub. Date: Aug. 2, 2007

(54) Remote control system for controlling wall-mounted switches

(76) Inventors: Zion Mor, Modiln (IL); Yitzhak Oren, Shoham (IL)

Correspondence Address: Martin D. Moynihan;PRTSI, Inc., P.O. Box 16446, Arlington, VA, 22215, US

(21) Appl. No.: 11/345,397

(22) Filed: Feb. 2, 2006

(51) Int. Cl. G08C 19/12

(52) U.S. Cl. 340/825.72; 341/176

(57) ABSTRACT

A remote control system for controlling the operation of a wall-mounted switch includes: a remote control unit adapted to be located at a remote location with respect to the wall-mounted switch and having a depressible switch button; a local control adapted to be mounted on the wall of the wall-mounted switch and including a displaceable actuator to overlie the depressible switch button of the wall-mounted switch; and a wireless communication system between the remote control unit and the local control unit effective, upon depression of the depressible switch button of the remote control unit, to displace the actuator of the local control unit such as to depress the switch button of the wall-mounted switch.

### FIELD AND BACKGROUND OF THE INVENTION

The present invention relates to remote control systems, and particularly to systems for remotely controlling the operation of wall-mounted switches.

Wall-mounted switches, as used for controlling various electrical circuits, e.g. room illumination, are frequently located at locations which are, or become, inconveniently accessible to the user. For example, a light switch may be located within a room distant from its entrance such that the user must walk through a part of the room before reaching the light switch to turn-on the illumination. Another example is where the light switch is mounted on a wall which is subsequently covered, or desired to be covered, by a piece of furniture. In such cases, the common practice is to use extension cords, or to modify the existing wiring, to enable controlling the electrical circuit in a convenient manner.

An object of the present invention is to provide a remote control system for controlling the operation of a wall-mounted switch from a remote location which does not require extension cords or rewiring of the electrical system.

According to one aspect of the present invention, there is a provided a remote control system for controlling an electrical circuit, comprising: a remote control unit adapted to be located at a remote location with respect to the wall-mounted switch and having a depressible switch button; a local control adapted to be mounted on the wall of the wall-mounted switch and including a displaceable actuator to overlie the depressible switch button of the wall-mounted switch; and a wireless communication system between the remote control unit and the local control unit effective, upon depression of the depressible switch button of the remote control unit, to displace the actuator of the local control unit such as to depress the switch button of the wall-mounted switch.

According to further features of the invention, the local control unit includes a housing mountable by fasteners to the wall of the wall-mounted switch, with the displaceable actuator of the local control unit overlying the depressible button of the wall-mounted switch. In one described preferred embodiment, the housing is configured such that a part of the depressible switch-button of the wall-mounted switch is aligned with the displaceable actuator, and another part of the depressible switch-button is exposed for direct manual depression by a user. In another described embodiment, the displaceable actuator of the local control unit projects outwardly of its housing so as to make it accessible to the user for direct actuation by the user. Such constructions enable the wall-mounted switch also to be manually actuated where this is convenient to the user, or where the remote control system fails.

According to further features of the invention, the local control unit includes a chargeable battery for supplying the electrical power thereto, and an induction-type charging circuit for inductively charging the battery by the electrical circuit controlled by the wall-mounted switch. This feature reduces or eliminates the need for making any wired connections to the local control unit, or for periodically replacing batteries in the local control unit.

Further features and advantages of the invention will be apparent from the description below.

### BRIEF DESCRIPTION OF THE DRAWINGS

The invention is herein described, by way of example only, with reference to the accompanying drawings, wherein:

FIG. 1 pictorially illustrates one application of the present invention;

FIG. 2 is a block diagram illustrating the main components of a remote control system in accordance with the present invention;

FIG. 3 is a block diagram illustrating the local control unit of the remote control system of FIG. 2;

FIG. 4 is a top plan view illustrating the local control unit of FIG. 3 as applied to a wall-mounted switch;

FIG. 5 is a view similar to that of FIG. 4 but illustrating a modification in the construction of the local control unit to permit direct actuation of the wall-mounted switch; and

FIG. 6 is a side elevational view of the modified local control unit illustrated in FIG. 5.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

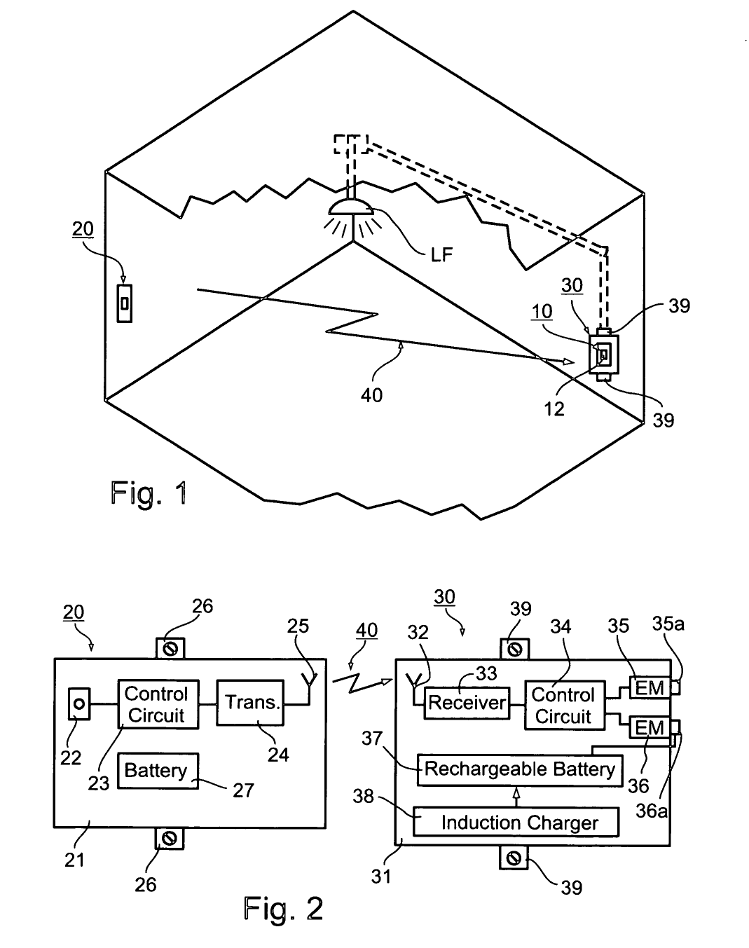

With reference to FIG. 1, there is illustrated a room containing a light fixture LF for illuminating the room, controlled by a conventional wall-mounted switch 10. In this case, the location of the wall-mounted switch 10 is at a distance from the entrance to the room. Such an arrangement would therefore sometimes make it necessary to walk through at least a part of the room before the light fixture is energized, in order to gain access to the wall-mounted switch for turning-on the light. The present invention is particularly useful in such a situation, since it enables the wall-mounted switch 10 to be controlled from a remote location, e.g. the entrance to the room, without rewiring the electrical system or otherwise disturbing the normal operation of the electrical system controlled by the wall-mounted switch 10.

The remote control system schematically illustrated in FIG. 1, and more particularly described in FIGS. 2-4, includes two main units: a remote control unit, generally designated 20, adapted to be located at a remote location with respect to that of the wall-mounted switch 10; and a local control unit, generally designated 30, adapted to be mounted on the wall of the wall-mounted switch 10, and to be controlled by the remote control unit 20 via a wireless communication system 40 established between the two units.

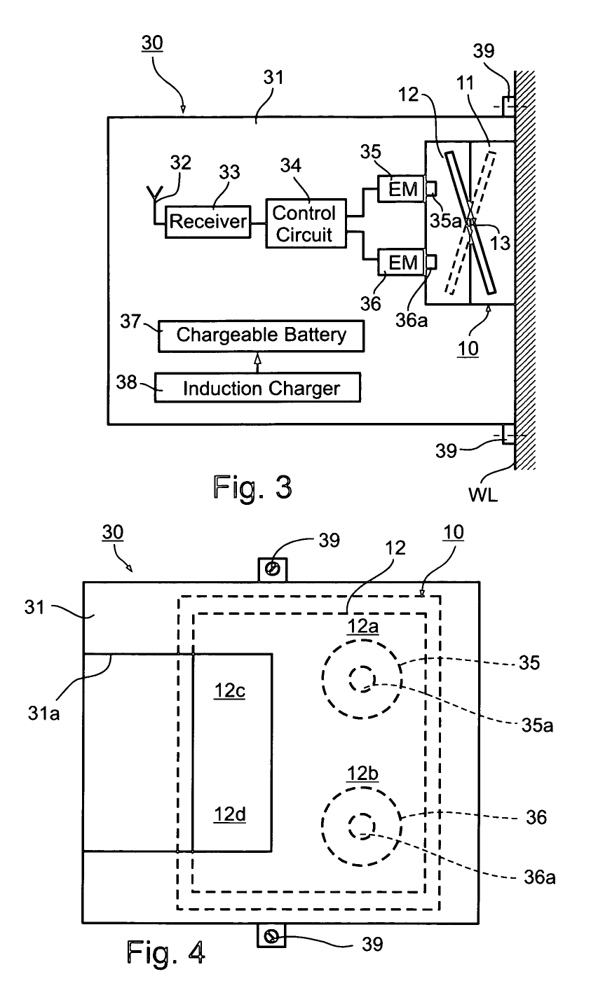

The wall-mounted switch 10 may be of any conventional construction. For purposes of illustration, it is shown in FIG. 3 as including a housing 11 mounted to the wall WL in any suitable manner, and a switch button 12 which is depressible for controlling an electrical circuit, e.g. the electrical circuit to the light fixture LF (FIG. 1). Switch button 12 is of the pivotal type, adapted to be pivotal about axis 13 to either the full-line position shown in FIG. 3, or to the broken-line position illustrated in FIG. 3. Thus, in one position, the switch button 12 is effective to energize the light fixture LF, and in the other position it is effective to de-energize the light fixture. Normally, push-button 12 is actuated to its full-line position by applying finger-pressure to the lower portion of the push-button (i.e. the portion below its pivotal axis 13), and is actuated to its broken-line position by applying finger-pressure to the upper portion of the push-button.

In conventional wall-mounted switches of this type, the push-button is retained in either actuated position by retaining elements within its housing 11 until finger-pressure is applied to actuate it to the other position.

Since the present invention does not involve any particular structure of wall-mounted switch but may be used with various types of wall-mounted switches, further details of the construction and operation of wall-mounted switch 10 are not set forth herein.

FIG. 2 diagrammatically illustrates the main components of the remote control unit 20 adapted to be located at a remote location with respect to wall-mounted switch 10 for controlling that switch, and the main components of the local control unit 30 adapted to be mounted on the wall of the wall-mounted switch for controlling it under the control of the remote control unit 20. FIG. 2 also illustrates, at 40, the wireless communication path between remote control unit and local control unit 30.

Thus, as diagrammatically shown in FIG. 2, remote control unit 20 includes a housing 21 having a manually-operated switch 22 of any suitable type, such as of the depressible switch-button type as wall-mounted switch 10. Remote control unit 20 further includes a control circuit 23 and a transmitter 24 transmitting, via an antenna 25, a control signal whenever switch 22 is manually operated. Remote control unit 20 is also preferably wall-mounted, and therefore includes any suitable mounting elements, such as mounting lugs 26, for mounting the unit onto the wall. It will be appreciated, however, that remote control unit 20 could also be a portable unit carried by the user.

Remote control unit 20 also preferably includes its own power supply, such as a battery 27, to eliminate the need for making any electrical connections between that unit and the electrical system of the wall-mounted switch 10. Since remote control 20 is conveniently accessible to the user, as distinguished from the local control unit 30, battery 27 can be conveniently replaced whenever necessary.

As further diagrammatically shown in FIG. 2, the local control unit 30, which is adapted to be mounted on the wall WL of the wall-mounted switch 10, includes a housing 31 containing an antenna 32 for receiving the electrical signal transmitted from antenna 25 of the remote control unit 20, a receiver 33 for amplifying and otherwise processing the received signal, a control circuit 34 having an input from receiver 33, and a pair of electromagnets 35, 36 controlled by the outputs from control circuit 34. Each of the electromagnets 35, 36 includes a plunger 35a, 36a, respectively, adapted to be axially displaced in one direction when its electromagnet is energized, and in the opposite direction when its electromagnet is de-energized. As will be described more particularly below, plungers 35a, 36a of electromagnets 35, 36 are effective to actuate the wall-mounted switch 10.

To enable the local control unit 30 to be electrically powered without any electrical connection to the electrical circuit controlled by the wall-mounted switch 10, local control unit 30 also includes its own battery 37. However, since the local control unit may be located at a location which is not conveniently accessible to the user, e.g. behind heavy furniture or the like, battery 37 is preferably of the rechargeable type, and is rechargeable by an induction charger 38 from the electrical system controlled by the wall-mounted switch 10. Such induction charges are well known, for example, in powered toothbrushes and other small appliances. Housing 31 of the local control unit 30 may be mounted in any suitable manner, such as by fasteners passing through lugs 39, to enclose the wall-mounted switch 10, as shown in FIGS. 1 and 3.

FIGS. 3 and 4 more particularly illustrate the manner in which electromagnets 35 and 36 of the local control unit 30 control, via their plungers 35a and 36a, respectively, the operation of the wall-mounted switch 10.

As shown in FIG. 3, the local control unit 30 is mounted to the wall WL to align the two electromagnet plungers 35a, 36a with the opposite ends of the depressible switch button 12 of switch 10. Thus, when electromagnet 35 is energized, its plunger 35a is projected outwardly against the upper portion of switch button 12 to actuate it to its broken-line position, and when electromagnet 36 is energized its plunger 36a is projected outwardly to actuate switch button 12 to its full-line position shown in FIG. 3. As mentioned earlier, switch 10 itself would include elements for retaining push-button 12 in either of its positions until actuated by one of the plungers, and therefore electromagnets 35, 36 need only be pulsed, rather than continuously energized, in order to actuate the wall-mounted switch 10.

FIG. 4 diagrammatically illustrates the configuration of housing 31 of the local control unit 30, and the manner of mounting it with respect to wall switch 10. Thus, as shown in FIG. 4 when local control unit 30 is mounted by fasteners passing through lugs 39 as described above, the plungers 35a, 36a of the two electromagnets 35, 36 are aligned with only a portion of the opposite sides of switch button 12, indicated at 12a and 12b, respectively, in FIG. 4. Housing 31 of the local control unit 30 is formed with a window or opening 31 a to expose the opposite sides of another portion of switch-button 12, designated 12c, 12d in FIG. 4, for direct contact by the finger of a user, should it be necessary or desirable for the user to directly actuate switch 10, rather than actuate it through the remote control unit 20. Such an arrangement enables the wall-mounted switch 10 to be actuated not only by the remote control unit 20 as described above, but also by directly depressing push-button 12. Such direct operation may be necessary because of a failure of an electrical component in the remote control unit 30 or local control unit 20, or may be desirable because of the physical presence of the user in the immediate vicinity of the wall-mounted switch 10.

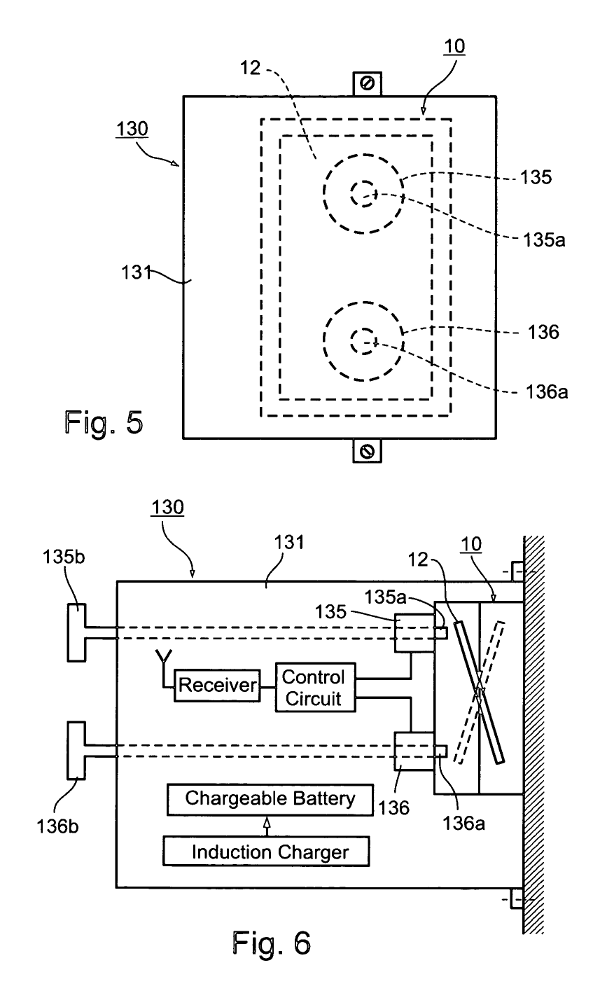

FIGS. 5 and 6 illustrate a variation in the construction of the local control unit, therein designated 130, in which the two plungers 135a, 136a, for the two electromagnets 135, 136, respectively, are extended externally of the housing 131, and carry enlarged heads 135b, 136b (FIG. 5) engageable by a finger of the user to directly actuate the wall-mounted switch, e.g. when this is more convenient to the user, and/or a malfunction occurs in one of the control units.

While the invention has been described with respect to two preferred embodiments, it will be appreciated that these are set forth for purposes of example only, and that the invention could be implemented in other constructions. For example, the invention could be implemented with only one electromagnet, for actuating the switch in one direction, the switch being actuated in the opposite direction by a return spring or the like. Also, the invention could be implemented in wall-mounted switches which include two or more push-button switch operators. Further, the wireless communication could be effected via infrared or sonar, rather than via RF. Other mounting means could be used, for example, a pressure-sensitive adhesive layer protected by a plastic film to be peeled away at the time of use.

The remote control unit could also be programmed to control, e.g. by transmitting selected pulse codes, other wall-mounted switches, or other types of electrical devices, such as turning-on an air conditioner system, heating system, coffee pot, or the like, from a remote location. The remote control system could also be incorporated in a central computer system performing many diverse functions at the respective location, including temperature measurement, pressure measurement, intrusion detection, etc.

Still many other variations, modifications and applications of the invention will be apparent.

What is claimed is:

1. A remote control system for controlling the operation of a wall-mounted switch having a depressible switch button for controlling an electrical circuit, comprising:
a remote control unit adapted to be located at a remote location with respect to said wall-mounted switch and having a depressible switch button;
a local control adapted to be mounted on the wall of said wall-mounted switch and including a displaceable actuator to overlie said depressible switch button of the wall-mounted switch;
and a wireless communication system between said remote control unit and said local control unit effective, upon depression of said depressible switch button of the remote control unit, to displace said actuator of the local control unit such as to depress said switch button of the wall-mounted switch.

2. The remote control system according to claim 1, wherein said displaceable actuator includes an electromagnet within said local control unit.

3. The remote control system according to claim 2, wherein said local control unit includes two electromagnets, each having a plunger displaceable by the energization of the respective electromagnet, said local control unit being mountable to said wall such that one of said plungers overlies one end of said depressible switch button for pivoting it in one direction, and the other of said plungers overlies the opposite end of said depressible switch button for pivoting it in the opposite direction.

4. The remote control system according to claim 3, wherein said plungers are extended to project outwardly of the local control unit such as to make them accessible to the user to enable the user to directly actuate the wall-mounted switch.

5. The remote control system according to claim 1, wherein said local control unit includes a housing configured such that a part of the depressible switch button of the wall-mounted switch is aligned with said displaceable actuator, and another part of the depressible switch button is exposed for direct manual depression by a user.

6. The remote control system according to claim 1, wherein said wireless communication system is an RF system and includes an RF transmitter in said remote control unit, and an RF receiver in said local control unit.

7. The remote control system according to claim 1, wherein said remote control unit is also in the form of a wall-mounted switch adapted to be mounted to a wall at a remote location with respect to said wall-mounted switch whose operation is to be controlled via said wireless communication system.

8. The remote control system according to claim 1, wherein said local control unit includes a chargeable battery for supplying the electrical power thereto, and an induction-type charging circuit for inductively charging said battery by the electrical circuit controlled by said wall-mounted switch.

9. The remote control system according to claim 1, wherein said local control unit includes a housing mountable by fasteners to the wall of said wall-mounted switch, with the displaceable actuator of the local control unit overlying said depressible button of the wall-mounted switch.

10. The remote control system according to claim 9, wherein said housing of the local control unit is configured such that a part of the depressible switch button of the wall-mounted switch is aligned with said displaceable actuator, and another part of the depressible switch button is exposed for direct manual depression by a user.

11. A remote control system for controlling the operation of a wall-mounted switch having a depressible switch button for controlling an electrical circuit, comprising:
a remote control unit adapted to be located at a remote location with respect to said wall-mounted switch and having a depressible switch button;
a local control adapted to be mounted on the wall of said wall-mounted switch and including a displaceable actuator to overlie said depressible switch button of the wall-mounted switch;
and a wireless communication system between said remote control unit and said local control unit effective, upon depression of said depressible switch button of the remote control unit, to displace said actuator of the local control unit such as to depress said switch button of the wall-mounted switch;
said local control unit including a housing configured such that a part of the depressible switch button of the wall-mounted switch is aligned with said displaceable actuator, and another part of the depressible switch button is exposed for direct manual depression by a user.

12. The remote control system according to claim 11, wherein said displaceable actuator includes an electromagnet within said local control unit.

13. The remote control system according to claim 12, wherein said local control unit includes two electromagnets, each having a plunger displaceable by the energization of the respective electromagnet, said local control unit being mountable to said wall such that one of said plungers overlies one end of said depressible switch button for pivoting it in one direction, and the other of said plungers overlies the opposite end of said depressible switch button for pivoting it in the opposite direction.

14. The remote control system according to claim 11, wherein said remote control unit is also in the form of a wall-mounted switch adapted to be mounted to a wall at a remote location with respect to said wall-mounted switch whose operation is to be controlled via said wireless communication system.

15. The remote control system according to claim 11, wherein said local control unit includes a battery for supplying the electrical power thereto.

16. A remote control system for controlling the operation of a wall-mounted switch having a depressible switch button for controlling an electrical circuit, comprising:
a remote control unit adapted to be located at a remote location with respect to said wall-mounted switch and having a depressible switch button;
a local control adapted to be mounted on the wall of said wall-mounted switch and including a displaceable actuator to overlie said depressible switch button of the wall-mounted switch;
and a wireless communication system between said remote control unit and said local control unit effective, upon depression of said depressible switch button of the remote control unit, to displace said actuator of the local control unit such as to depress said switch button of the wall-mounted switch;
said local control unit including a chargeable battery for supplying the electrical power thereto, and an induction-type charging circuit for inductively charging said batter by the electrical circuit controlled by said wall-mounted switch.

17. The remote control system according to claim 16, wherein said displaceable actuator includes an electromagnet within said local control unit.

18. The remote control system according to claim 17, wherein said local control unit includes two electromagnets, each having a plunger displaceable by the energization of the respective electromagnet, said local control unit being mountable to said wall such that one of said plungers overlies one end of said depressible switch button for pivoting it in one direction, and the other of said plungers overlies the opposite end of said depressible switch button for pivoting it in the opposite direction.

19. The remote control system according to claim 16, wherein said remote control unit is also in the form of a wall-mounted switch adapted to be mounted to a wall at a remote location with respect to said wall-mounted switch whose operation is to be controlled via said wireless communication system.

20. The remote control system according to claim 16, wherein said wireless communication system is an RF system and includes an RF transmitter in said remote control unit, and an RF receiver in said local control unit.
